(19) United States
(12) Patent Application Publication
(10) Pub. No.: US 2009/0230706 A1
(43) Pub. Date: Sep. 17, 2009

(54) MECHANICAL DEVICE FOR GRIPPING THE INSIDE OF HOLLOW OR BORED BODIES

(76) Inventor: Giuseppe MAFFEIS, Roncadelle (IT)

Correspondence Address: MCGLEW & TUTTLE, PC, P.O. BOX 9227, SCARBOROUGH STATION, SCARBOROUGH, NY, 10510-9227, US

(21) Appl. No.: 12/399,158

(22) Filed: Mar. 6, 2009

(30) Foreign Application Priority Data
Mar. 14, 2008 (IT) BS 2008 A 000055

(51) Int. Cl. B65G 7/12; B66C 3/00; B25B 3/00

(52) U.S. Cl. 294/96

(57) ABSTRACT

This invention concerns a device for gripping the inside of hollow or bored items, that comprises a prehensile device (11) with a supporting head (14), so as to undertake a contracted inactive position, and an expanded active one; a divaricator (12) inserted in the prehensile device (11) movable between a first and a second position to respectively define the contracted and expanded positions of said prehensile device (11)), and a control lever fulcrated to the supporting head (14) and connected to the divaricator (12) to provoke the movements of the latter between the first position in which the device is in the contracted position and the second position in which the prehensile device is in the expanded position.

### FIELD OF THE INVENTION

This invention concerns a device for gripping the inside of hollow or bored items in order to move and handle them during operation, treatment or assembly phases.

### STATE OF THE ART

Expanding/contractible devices, such as the so called finger gripper, which can have pneumatic control, are available for gripping the inside of hollow or bored bodies or items which however cannot be gripped on the outside. However, due to their configuration and the fact that they are subject to intense wear, they are not suitable and efficient when the bodies or items to be handled are particularly heavy and the cavity or bore has uneven or grooved surfaces and said bodies or items need to be reliably sustained.

### OBJECTS AND SUMMARY OF THE INVENTION

One of the objects of this invention is to propose a purely mechanical device suitable to effectively facilitate the inside gripping of hollow bodies or items and to sustain them safely even if they are heavy and with uneven or grooved internal surfaces.

Another object of the invention is to provide a device which is simple and economic to make, practical and easy to control and use, substantially without wear and which when used can also be hung on a means of suspension, a chain conveyer or a similar translating device.

Said objects and implicit advantages deriving from them are achieved, according to the invention, with a gripper device that comprises a prehensile member with a supporting head, forming an axial seat and able to take on a contracted inactive position and an active expanded position; a divaricator mounted in said axial seat and moving between a first and a second positions to respectively define the contracted and expanded positions of said prehensile member; and a control lever fulcrated on said supporting head and connected to the divaricator to provoke the movements of the latter, from the first position, in which the prehensile member is in the inactive position, to the second position, in which the prehensile member is in the active position.

The prehensile member and the relative supporting head are made of a metal material and preferably form an integral part.

In turn, the prehensile member has a number of flexible sectors each provided, internally, with a conical portion with which the divaricator interacts to cause its contraction and expansion and, externally, with a lug to engage with the internal surface of the body or item preferably on a level with a groove or undercut thereof.

### BRIEF DESCRIPTION OF THE DRAWINGS

The invention will, however, be illustrated in greater detail in the following description made in reference to the attached drawings, in which:

FIG. 1 is an exploded view of the components of the device;

FIG. 2 is a view in perspective of the assembled device in an inactive position;

FIGS. 3 and 4 respectively are a side view and a cross section view of the device in the inactive position in FIG. 2;

FIG. 5 is a view in perspective of the assembled device in the active position; and

FIGS. 6 and 7 respectively are a side view and a cross-section of the device in the active position as in FIG. 5.

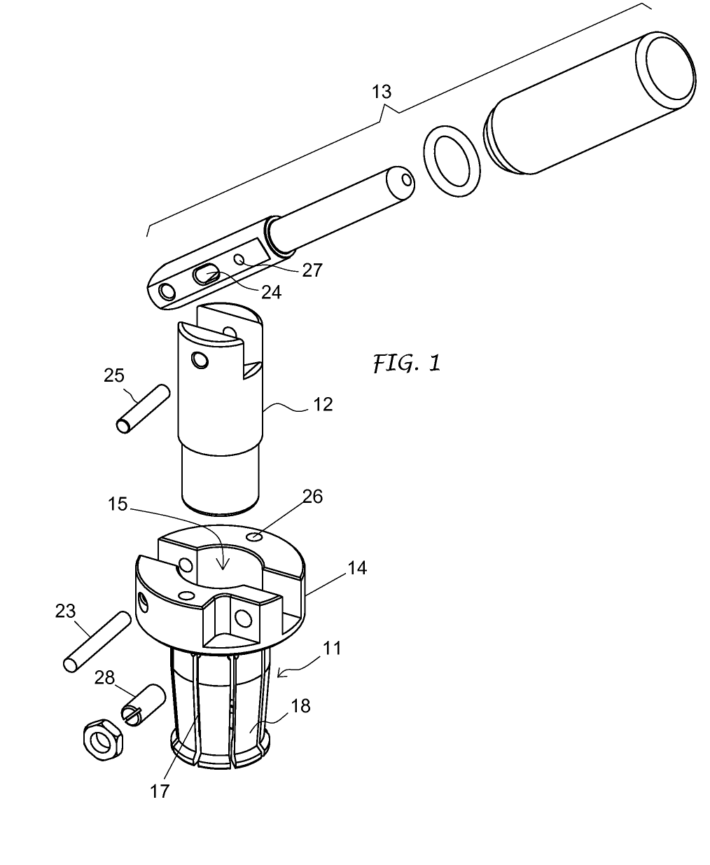

### DETAILED DESCRIPTION OF THE INVENTION

As shown, the gripper device basically comprises a prehensile member 11, a divaricator 12 and a control lever 13.

The prehensile member 11 is made of a metal material and a supporting head 14 with which it forms a single piece and delimits an axial seat 15. The supporting head 14 has a base which defines an annular supporting plane 16 facing towards the prehensile member, around the latter.

The prehensile member 11 is basically cylindrical and has longitudinal cuts 17 to divide it into several flexible sectors 18, which can move radially between a contracted inactive position and an expanded active one. Each of said flexible sectors 18 is provided internally, near its free end, with a protrusion 19 with an initial conical bevelled portion 20 and, externally with a lug 21 also with a bevel 22.

The movements of the flexible sectors 18 from one position to another are caused by the divaricator 12, which is connected and movable axially by means of the control lever 13. The divaricator 12 is housed in the axial seat 15 of the prehensile member 11 and can be moved between a first position, in which it is retracted and distant from the internal protrusions 19 of the flexible sectors 18 of the prehensile member and a second position, in which it is forwarded and its end engages with said internal protrusions 19.

The control lever 13 is fulcrated with a pivot 23 to the supporting head 14 and has a slot 24 in which a pin 25 extends and slides, connecting the lever to the divaricator 12. In this way, the angular movements of the lever 13 correspond to the axial movements of the divaricator 12 between the first position and the second position defined above.

On the other hand, the supporting head 14 of the prehensile member 11 can be provided with bores 26 or various other types of connections for attaching the device and any type of suspension element, chain, conveyer or the like for its handy use and smooth handling according to requirements.

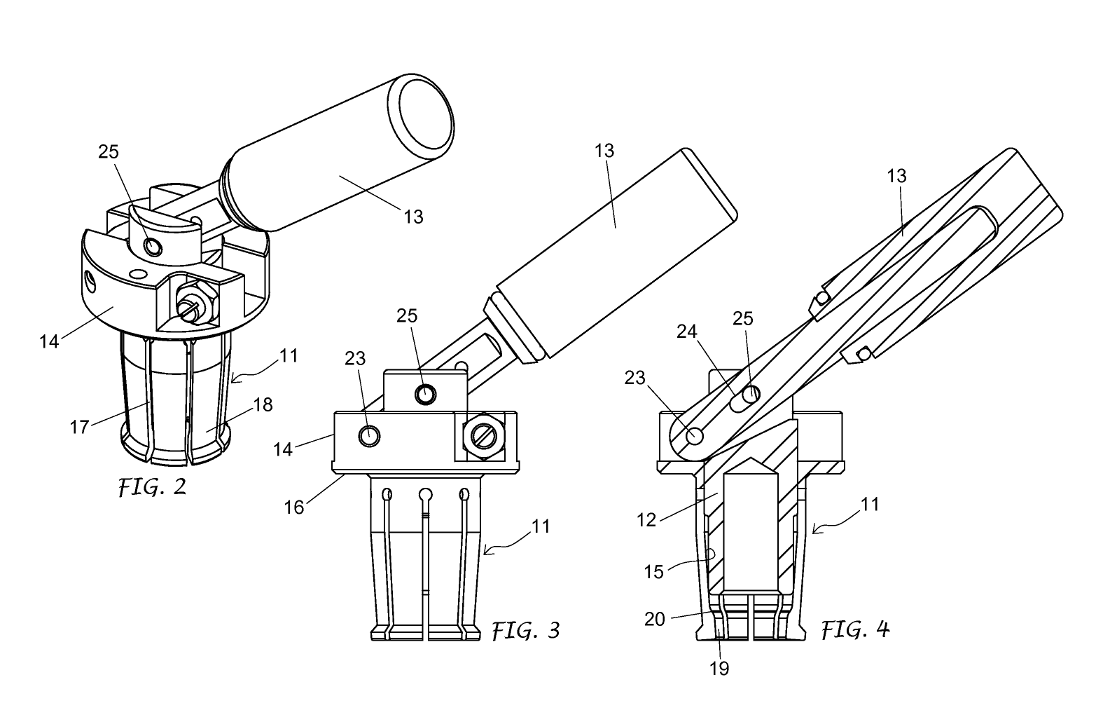

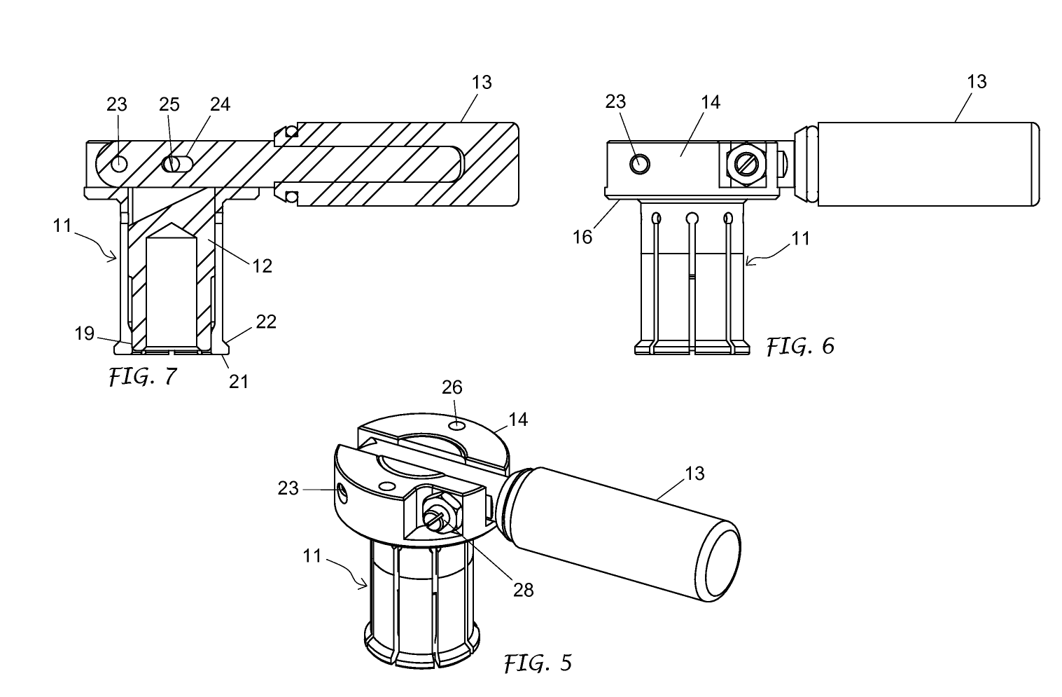

The flexible sectors 18 of the prehensile device 11 are arranged and loaded elastically to be and to remain normally in the contracted position when the divaricator 12 is the retracted position as shown in FIGS. 2-4. In this condition, the prehensile member 11 can be inserted each time, as far as the supporting plane 16 at the base of the supporting head 14, in a cavity or a bore of the body or item—not shown—to be gripped, handled, suspended and/or moved. Then the prehensile member 11 can be activated by using the control lever 13 in the direction to move the divaricator 12 forward so as to engage the internal protrusions 19 of the flexible sectors 18 and to expand in this way the prehensile member as shown in FIGS. 5-7. Therefore, the external lugs 21 of the flexible sectors 18 will engage tightly and block on the internal surface of the cavity or bore in which the prehensile member has been inserted. To support the suspension of the body or item besides the gripping process, the cavity or the bore can be provided with or have an internal groove in which to insert the external lugs 21 of the prehensile member 11.

Furthermore, when the divaricator 12 is moved forward and engages with the internal protrusions 19 to determine the expansion of the flexible sectors of the prehensile member, it is impossible to retract it unless the control lever is intentionally used, thus ensuring the efficiency of the device.

However it can also be made possible for the lever to be stopped and restrained in its operation position of the prehensile member. For this purpose, the control lever 13 can be provided on one side with a cavity 27 and, on the supporting head 14 of the prehensile member 11 can be mounted a spring stop 28 designed to engage in said cavity, to stabilize the position of the lever when the latter is turned in the expansion position of the prehensile member.

1. Device for gripping the inside of hollow or bored bodies, characterized in that it comprises:
a prehensile member (11) with a supporting head (14), defining an axial seat (15) and made to undertake a contracted inactive position and an active expanded position;
a divaricator (12) mounted and sliding in said axial seat (15) and movable between a first and second position to respectively define the contracted and expanded positions of said prehensile member (11), and
a control lever (13) fulcrated to said supporting head (14) and connected to the divaricator (12) to cause the movements of the latter between said first position, in which the prehensile member is in the contracted inactive position, and said second position in which the prehensile member is in the expanded, active position.

2. Device according to claim 1, wherein the prehensile member (11) is made of a metal and forms a single piece together with the supporting head (14), and wherein an annular supporting plane (16) is provided between the prehensile member and the supporting head.

3. Device according to claim 1, wherein the prehensile member (11) is basically cylindrical and divided into several elastically loaded flexible sectors (18) so as to maintain them in a normal contracted position when the divaricator (12) is in the first position.

4. Device according to claim 3, wherein said flexible sectors (18) have internal protrusions (19) designed to engage with the divaricator (12) when the latter is in the second position so as to stabilize the expanded position of the prehensile member (11).

5. Device according to claim 3, wherein the flexible sectors (18) of the prehensile member has external lugs (21) designed to engage with a groove inside the body or item to be gripped.

6. Device according to claim 1, wherein the control lever (13) is fulcrated to the supporting head (14) and connected to the divaricator (12) so that the angular movements of the control lever (13) correspond to the axial movements of the divaricator (12) between said first and second position.

7. Device according to claim 6, wherein the control lever (13) has a slot (24) and the divaricator (12) is connected to said lever by means of a through transversal pin (25) and sliding in said slot.

8. Device according to claim 1, wherein said supporting head (14) is equipped with means (26) for fixing the device to a supporting element, which is either stationary or movable.

9. Device according to claim 6, wherein said control lever (13) has an indent (27) designed to engage with an elastic stop (28) mounted on the supporting head to stabilize the position of the lever when the divaricator is in said second position.
